(19) United States
(12) Patent Application Publication
(10) Pub. No.: US 2008/0005665 A1
(43) Pub. Date: Jan. 3, 2008

(54) Information delivery system

(75) Inventor: Yuichi Sakuraba, Musashino-shi (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/811,577

(22) Filed: Jun. 11, 2007

(30) Foreign Application Priority Data
Jun. 16, 2006 (JP) 2006-167182

(51) Int. Cl. G06F 17/00

(52) U.S. Cl. 715/513

(57) ABSTRACT

A file obtained by converting event information into information in RSS or Atom format is held in a web server. The file is periodically read and displayed by using an RSS reader. A general web server and a general RSS reader can be used, and since HTTP is used, an existing security technique such as SSL can be used.

This application claims foreign priority based on Japanese Patent application No. 2006-167182, filed Jun. 16, 2006, the content of which is incorporated herein by reference in its entirety.

### BACKGROUND OF THE INVENTION

1. Field of the Invention

The present invention relates to an information delivery system and, in particular, relates to an information delivery system suitable for use in delivering an event and an alarm of a small degree in a process control system.

2. Description of the Related Art

Usually, an event generated in a plant or a factory is browsed by using a dedicated event delivery system. FIG. 3 shows the configuration of the event delivery system that can browse events remotely. In FIG. 3, an event browsing apparatus 10 and an event delivery section 14 are connected to each other by a network 12 via a firewall 11 and a firewall 13. An output of an event logger 15 is inputted to the event delivery section 14. The event browsing apparatus 10 and the firewall 11 are disposed on a client side, whilst the firewall 13, the event delivery section 14 and the event logger 15 are disposed on a control system side.

The event delivery section 14 delivers events by using the Window Messenger System. To this end, the event delivery section 14 converts an event outputted from the event logger 15 into an event in the Instant Message format, and transmits the event to the event browsing apparatus 10 via the network 12. The event browsing apparatus 10 displays the event thus received. In this manner, events generated in a plant or a factory are delivered to a client.

JP-A-2001-56896 describes a measurement system which can grasp the operation state of a measurement apparatus coupled to a network. The gist of the measurement system will be explained with reference to FIG. 4. In FIG. 4, reference numeral 20 denotes the measurement apparatus in which a measurement means 21, a response means 22, an own information notifying means 23 and a communication means 24 are disposed. Reference numeral 25 denotes a computer in which a communication means 26, a control means 27 and a memory means 28 are disposed. The measurement apparatus 20 is coupled to the computer 25 via a network 29.

The control means 27 is operated by software stored in the memory means 28. The control means 27 broadcasts an inquiry to the measurement apparatus 20, and the response means 22 transmits own information in response to the inquiry. When an event such as turning-on/off of the power supply of the measurement apparatus 20 is generated, the own information notifying means 23 outputs the own information to the network 29. The computer fetches this information. Accordingly, the computer can know a measurement apparatus newly coupled to the network 29 or a measurement apparatus having been removed from the network 29.

JP-A-2005-322016 describes a server apparatus and an information delivery method. The gist of the server apparatus and the information delivery method will be explained with reference to FIG. 5. In FIG. 5, a personal computer 30 is coupled to a web server 32 via a network 38. In response to a request from a browser 31, an HTTP (HyperText Transfer Protocol) server 35 reads HTML (HyperText Markup Language) data from a waveform measurement section 37, and sends the data to the browser 31 via an HTTP interface 36 and the network 38.

An event delivery system 33 monitors an event generated in the waveform measurement section 37. When the browser 31 requests an event delivery service via the HTTP server 35, the event delivery system 33 dynamically generates an event delivery interface 34 and notifies of the generation of the event in a protocol different from the HTTP. When the browser 31 receives this notification, the browser requests information of the event to the HTTP server 35 and displays the transmitted information. The browser 31 can update information in real time in synchronism with the generation of an event, and the event delivery interface 34 is dynamically generated in response to the event request, whereby an unauthorized access can be prevented.

However, since the event delivery system shown in FIG. 3 uses the instant message, there arises a problem that users as well as the event delivery system are limited in WINDOWS® environment. Further, it is required to use MSNP (Microsoft Network Protocol) dedicated for the Window Messenger as the protocol, and a communication port is limited to port 1863. Thus, there is a case that the usage is limited due to the security problem such as firewall, and so there also arises a problem that a secure communication path such as VPN (Virtual Private Network) is sometimes required to be used additionally.

The measurement system of JP-A-2001-56896 requires the own information notifying means and hence the configuration thereof becomes complicated. Further, JP-A-2001-56896 does not consider the transmission of an event which is the object of the invention. The server apparatus and the information delivery method of JP-A-2005-322016 require the event delivery system using the protocol uniquely prepared additionally for the event transmission and hence there arises a problem that the configuration thereof becomes complicated.

### SUMMARY OF THE INVENTION

The present invention has been made in view of the above circumstances, and provides an information delivery system in which an ordinary-used web server can be used as it is, and which is not limited to the WINDOWS® environment.

In some implementations, an information delivery system of the invention, comprising:

an information conversion section which converts information into information in a format capable of being delivered by using HTTP (Hyper Text Transfer Protocol), and generates a file having the converted information;

a web server which holds the file generated by the information conversion section; and

a reader which reads from the web server the file generated by the information conversion section, and displays the read file.

Since HTTP is used, an existing web server or an existing reader can be used.

In the information delivery system, the format is RSS (Rich Site Summary), and

the reader can read the file in the RSS format.

Thus, an existing technique can be applied.

In the information delivery system, the format is Atom, and

the reader can read the file in the Atom format.

Thus, an existing technique can be applied.

In the information delivery system, the information is event information or an alarm.

Thus, it is quite effective when the information delivery system is applied to the transmission of an event or an alarm.

In the information delivery system, the information is a daily report, a weekly report or a monthly report.

Thus, it is quite effective when the information delivery system is applied to these.

In the information delivery system, the information is operation information of a device in a control system.

Thus, it is quite effective when the information delivery system is applied to these.

### BRIEF DESCRIPTION OF THE DRAWINGS

FIG. 1 is a diagram showing the configuration of an embodiment according to the invention.

FIG. 2 is a flowchart showing the operation of the embodiment according to the invention.

FIG. 3 is a diagram showing the configuration of an event delivery system of a related art.

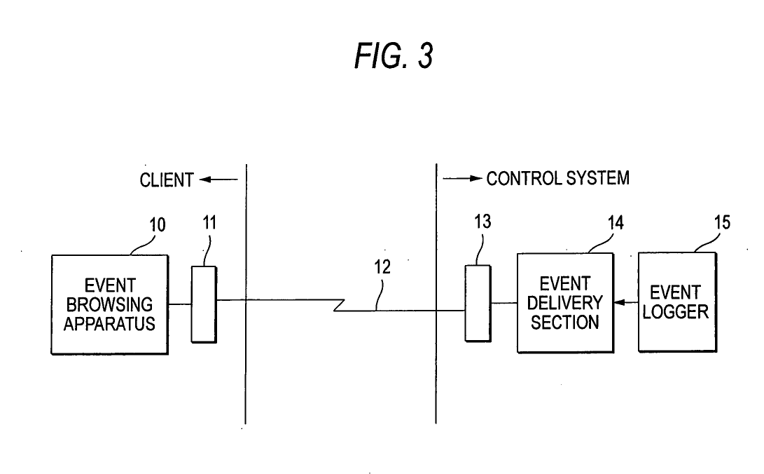

FIG. 4 is a diagram showing the configuration of a measurement system of the related art.

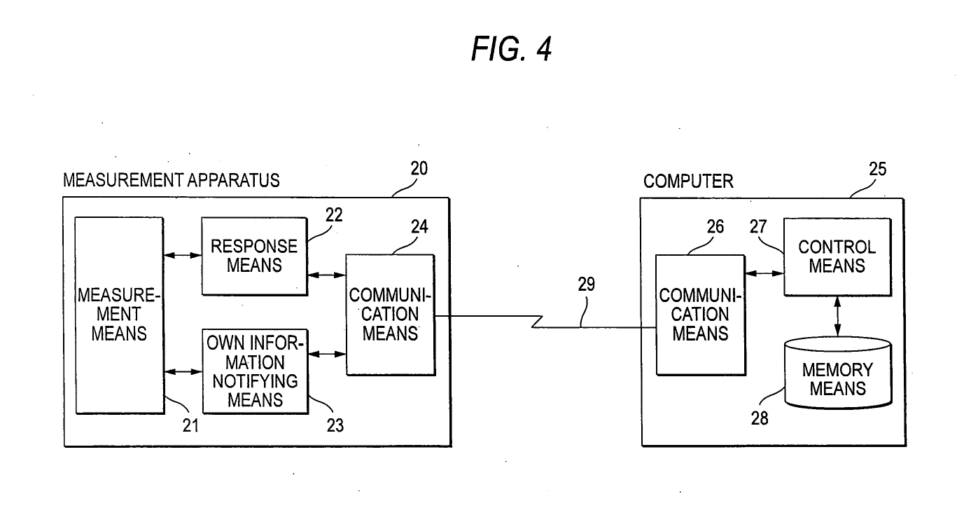

FIG. 5 is a diagram showing the configuration of an information delivery apparatus of the related art.

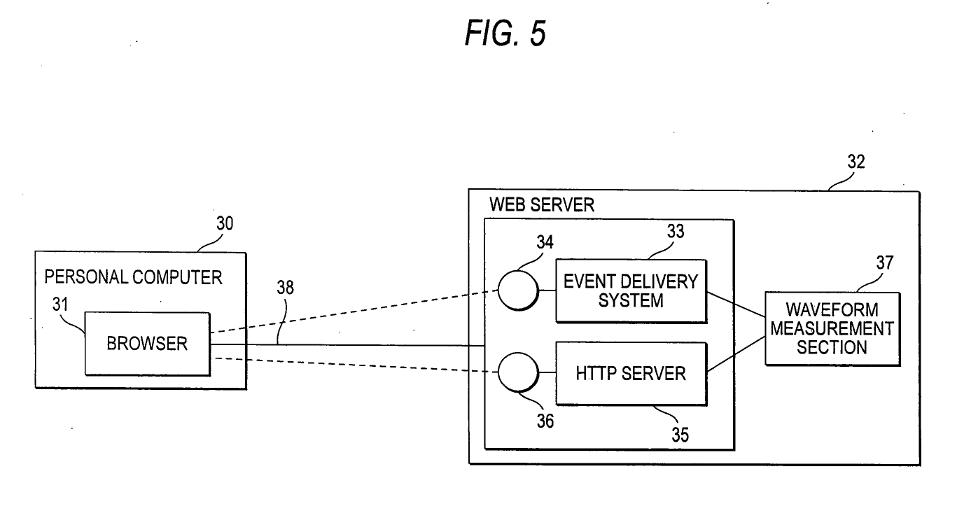

### DESCRIPTION OF THE PREFERRED EMBODIMENTS

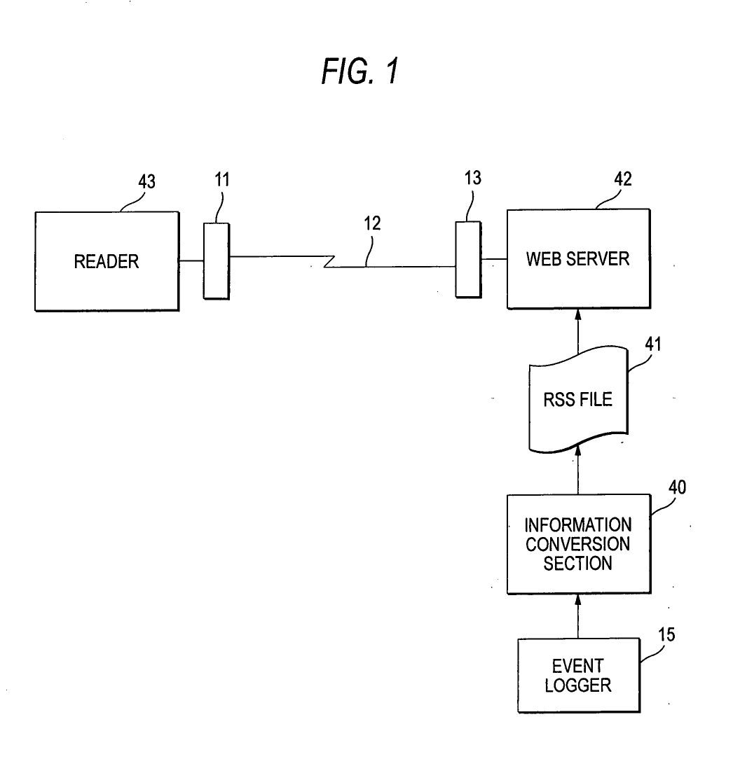

The present invention will be explained in detail with reference to the drawings. FIG. 1 is a diagram showing the configuration of an embodiment of an information delivery system according to the invention. The system intends to deliver an event. In FIG. 1, reference numeral 40 denotes an information conversion section to which event information is inputted from an event logger 15. The information conversion section 40 generates a file which is obtained by converting the event information into that in RSS (Rich Site Summary) format or Atom format. An RSS file 41 is the file thus generated. The event logger 15 is a part for recording an event or an alarm among an application group constituting a control system.

RSS is the XML (eXtensible Markup Language) format which structurally describes metadata of an index or an abstract of a web site, etc., and is mainly used in order to open the updated information of the web site. A title, address, index, abstract, updated time, etc., of each page of the web site can be described in a document described by RSS. The updated information of many web sites can be grasped efficiently in a unified manner by using the document prepared in the RSS format.

Like RSS, Atom is the XML format which structurally describes the metadata of an index or an abstract of a web site, etc. Atom is devised as a new format, since a new version not compatible with the RSS appeared and it became difficult to use the RSS format because the specification of RSS became complicated.

Reference numeral 42 denotes a web server which holds the RSS file 41. Since RSS and Atom are described by the XML format, ordinary used Apache, etc., may be used as the web server 42.

The web server 42 is coupled to a reader 43 via a firewall 13, a network 12 and a firewall 11. The reader 43 makes rounds of the web server 42 in a designated cycle to download the RSS file 41. When the RSS file contains an updated portion, the reader 43 extracts and displays that portion. As the reader 43, a reader used for collecting the updated information of a web site is used. A web browser may be used in place of the reader 43.

HTTP is used for the communication between the reader 43 and the web server 42. Further, a port No. 80 which is used frequently may be used. Thus, there does not arise a problem that the usage of the information delivery system is limited due to the security problem by the firewall or the like.

Although RSS or Atom itself does not have a security function, security technique such as SSL which is frequently used in web browsers can be used as it is. Thus, the event can be delivered securely without using a special technique.

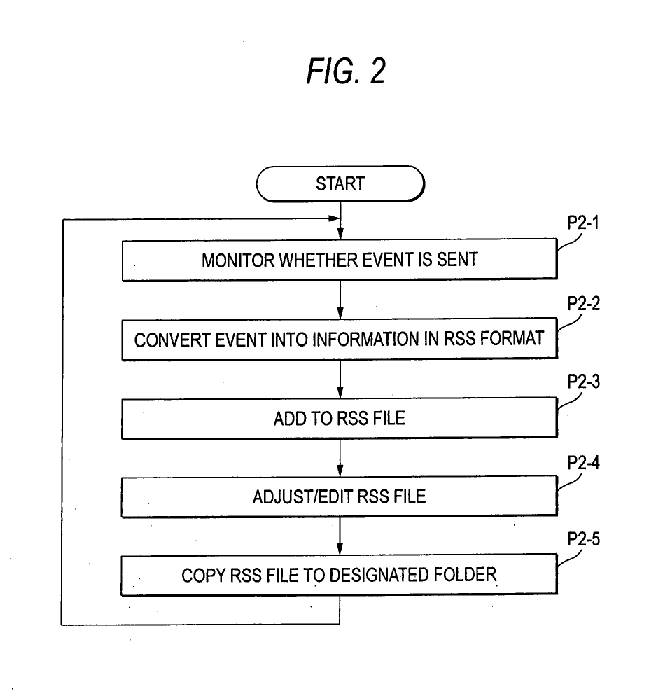

Next, the operation of the information conversion section 40 will be explained based on a flowchart shown in FIG. 2. In FIG. 2, in step (P2-1), it is monitored whether or not an event is sent from the event logger 15. When an event is sent, the event information thus sent is converted into that of the RSS format in step (P2-2), and the event information thus converted is added to the RSS file 41 in step (P2-3).

Then, in step (P2-4), the RSS file 41 is edited in step (P2-4). For example, when the size of the RSS file 41 becomes larger than a designated value, the information is sequentially deleted in the chronological order so that the size of the RSS file becomes equal to or smaller than the designated value. Further, when there is information older than a designated time range, that information is deleted.

When the edition/adjustment is completed, the RSS file 41 is copied to a designated folder in step (P2-5) so that the web server 42 can deliver the information, and the process returns to step (P2-1). As described above, the reader 43 reads the RSS file in a constant cycle and displays the changed portion.

In this manner, since the event information is automatically displayed, a user can know the generation of an event. Further, since information is delivered by using HTTP, a general web server or a general reader (web browser) can be used, and the general-purpose security technique such as SSL can be used.

Since HTTP is used, a so-called push delivery in which the web server 42 accesses the reader 43 can not be conducted and only a pull delivery in which the reader 43 accesses the web server 42 can be conducted. Since the reader 43 merely accesses the web server 42 periodically, the real time performance is degraded. Thus, it is necessary to separately deliver an important event or an alarm which is required to have good real time performance by a delivering method of high real time performance.

Although the embodiment is explained on condition that the RSS format is used, the Atom format may be used in place of the RSS format. In this case, a section capable of converting the event information into that of the Atom format may be used as the information conversion section 40, and a reader capable of handling the Atom format may be used as the reader 43. Further, an arbitrary browser can be used as long as the browser can read information in the RSS (or Atom) format.

Although each of RSS and Atom is a general format for delivering information by using HTTP, the invention is not limited thereto. An arbitrary format may be used so long as the information is delivered by using HTTP.

Further, although the embodiment is explained in the case of delivering an event, the embodiment may also be used in order to deliver periodically-generated information such as a daily report, a weekly report or a monthly report as well as an event and an alarm. Although the HTML document is more efficient in order to browse the daily report, the weekly report or the monthly report, it is possible to deliver them by using the RSS or Atom format.

Further, it is possible to deliver an operating state (operation information) of devices. A device management system may collect information of the devices by utilizing the information delivery system.

Furthermore, the invention may be utilized for a wide area system such as a meteorological system. The meteorological system may be arranged to deliver meteorological information by using the information delivery system of the invention, and then the meteorological information may be collected to obtain weather condition.

The present invention has various advantages.

According to the information delivery system of the invention, the file, which describes information such as an event in a format capable of being delivered by using HTTP, is held in the web server, and the file is periodically read by the reader.

Since HTTP is used, an existing web server can be used as it is, advantageously. Further, since the web server is used, information can be simultaneously browsed by a plurality of terminals, advantageously. Furthermore, an existing security technique such as SSL (Secure Socket Layer) can be used, advantageously.

Further, when a file to be held in the web server is described in RSS or Atom format, an existing reader can be used, advantageously.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. An information delivery system, comprising:
an information conversion section which converts information into information in a format capable of being delivered by using HTTP (Hyper Text Transfer Protocol), and generates a file having the converted information;
a web server which holds the file generated by the information conversion section; and
a reader which reads from the web server the file generated by the information conversion section, and displays the read file.

2. The information delivery system according to claim 1, wherein the format is RSS (Rich Site Summary), and
the reader can read the file in the RSS format.

3. The information delivery system according to claim 1, wherein the format is Atom, and
the reader can read the file in the Atom format.

4. The information delivery system according to claim 1, wherein the information is event information or an alarm.

5. The information delivery system according to claim 1, wherein the information is a daily report, a weekly report or a monthly report.

6. The information delivery system according to claim 1, wherein the information is operation information of a device in a control system.

7. The information delivery system according to claim 1, further comprising:
an event logger in a control system,
wherein the information conversion section receives the information from the event logger and converts the received information to the information in the format capable of being delivered by using the HTTP.
